(19) United States
(12) Patent Application Publication
(10) Pub. No.: US 2017/0099277 A1
(43) Pub. Date: Apr. 6, 2017

(54) Systems and Methods of External Entity Network Service Authentication

(71) Applicant: COX COMMUNICATIONS, INC., Atlanta, GA (US)

(72) Inventors: Joshua Shane Hutchins, Atlanta, GA (US); John Gammons, Hoschton, GA (US)

(73) Assignee: COX COMMUNICATIONS, INC., Atlanta, GA (US)

(21) Appl. No.: 14/875,068

(22) Filed: Oct. 5, 2015

(51) Int. Cl. H04L 29/06

(52) U.S. Cl. CPC H04L 63/08; H04L 63/10; H04L 63/0876; H04L 63/102

(57) ABSTRACT

Systems and methods are disclosed for providing external entity network authentication, including a processor comprising a computer-readable medium with a set of instructions operable to receive an authentication request for a subscriber device, authenticate the subscriber device at the content service provider, request subscriber device information from the network service provider at the content provider service, and provide access to content on the subscriber device based at least in part on subscriber device information.

### TECHNICAL FIELD

The present disclosure is generally related to authentication and, more particularly, is related to an external entity network service authentication.

### BACKGROUND

The proliferation of mobile networked devices has enabled device users to access a wide range of content via applications, social media, audio/video streaming, and websites, from nearly anywhere. One drawback to such near ubiquitous access to content is managing various separate accounts that are required for each application, social media network, streaming service, and website.

Content services providers face the challenge of ensuring data security with authentication measures that are not unduly onerous to the user/subscriber. Unfortunately, current authentication methods still largely involve use of a conventional username and password for each different content service. In some cases, this is required for each and every attempt to access a content service. There are heretofore unaddressed needs with previous solutions.

### SUMMARY

Example embodiments of the present disclosure provide systems for providing external entity network service authentication. Briefly described, in architecture, one example embodiment of the system, among others, can be implemented as follows: a processor comprising a computer-readable medium with a set of instructions operable to receive an authentication request from a subscriber device at a content service provider, the subscriber device request sent over a subscriber virtual network, authenticate the subscriber device at the content service provider, request subscriber device information from the network service provider at the content provider service, at the network service provider, provision access to the subscriber virtual network to the content service provider, and provide access to content on the subscriber device based at least in part on the subscriber device information.

Embodiments of the present disclosure can also be viewed as providing systems for providing external entity network service authentication. Briefly described, in architecture, one example embodiment of the system, among others, can be implemented as follows: a processor comprising a computer-readable medium with a set of instructions operable to receive an authentication request at a content service provider, the authentication request sent by a subscriber device over a subscriber virtual network provided by a network service provider, securely obtain subscriber device information from the network service provider, at the network service provider, provision access to the subscriber virtual network to the content service provider, and provide access to content on the subscriber device based at least in part on the subscriber device information.

According to still yet another embodiment of the present disclosure, example embodiments of the present disclosure provide external entity network service authentication that can be implemented as follows: a processor comprising a computer-readable medium with a set of instructions operable to receive an authentication request from a subscriber device at a content service provider, the subscriber device request sent over a network service provider network, authenticate the subscriber device at the content service provider, securely obtain subscriber device information from the network service provider at the content provider service; and provide access to content on the subscriber device based at least in part on subscriber device information.

### BRIEF DESCRIPTION OF THE DRAWINGS

FIG. 1 provides a system block diagram of an example embodiment of a system of external entity network service authentication.

FIG. 2 provides a system block diagram of an example embodiment of a system for supporting provision of external entity network service authentication.

FIG. 3 provides a diagram of an example embodiment of data from a subscriber device data repository used in the system of FIG. 2.

FIG. 4 provides a flow diagram of an example embodiment of a method for providing external entity network service authentication.

FIG. 5. provides a flow diagram of an example embodiment of a method for providing external entity network service authentication.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following description, numerous details are set forth to provide an understanding of the present disclosure. However, it will be understood by those of ordinary skill in the art that the present disclosure may be practiced without these details and that numerous variations or modifications from the described embodiments may be possible. The disclosure will now be described with reference to the figures, in which like reference numerals refer to like, but not necessarily the same or identical, elements throughout. For purposes of clarity in illustrating the characteristics of the present disclosure, proportional relationships of the elements have not necessarily been maintained in the figures.

Through mechanisms available to the internet service provider, customer network information, such as a user's device's MAC address, is available enabling the ability to automatically authenticate and authorize subsequent requests for access to a service (such as network access, website access, personalized video products, etc. . . . ). Furthermore, the service provider can use the information, as well as customer-managed data, to distinguish between various users on an account (such as parents vs. children, or a variety of authorized users the account manager has added as sub-accounts).

In an example embodiment, the client device may not be party to its authentication request. As the client device connects, the network may realize that the client device is a device that is not authenticated to have access, and the network initiates the request (or forwards the device to a portal for the user to interact and gain access via credentials). The client device may inform the network of some information that can be used for authentication/authorization (ie., the MAC address or perhaps even stored credentials). However, the call that initializes the request for access may source from the network, not the device. In an example embodiment, the request for authentication may be originate from many sources, including non-limiting examples of the network, the backend, the client device, or client applications. The authentication request may also be initiated by an external service if that external service recognizes the device as being within a particular network.

Example embodiments of the systems and methods of external entity network service authentication comprise a process by which external entities that request the internet service provider's customers to authenticate to their service (such as Netflix, Facebook, Google, etc. . . . ) can gain access and visibility to network-level data to securely and automatically authenticate/authorize users.

In achieving this visibility, the end user's network access is securely tunneled (via standard methods such as IPSEC over GRE/PMIP) to a centralized virtual network aggregator, giving a single point at which that customer's devices connect. The user then attempts to access and authenticate to an external entity with which a peering agreement has been built with the internet service provider. The internet service provider and external entity use a secure method (such as OAuth) to exchange and store additional information about the user (such as device MAC, additional devices associated to the user, additional information about account-associated users/devices, entitlements, etc. . . . ). The internet service provider then automatically provisions access to the customer's network (on the virtual network aggregator) for the external entity to give that entity direct visibility into the exchanged network information.

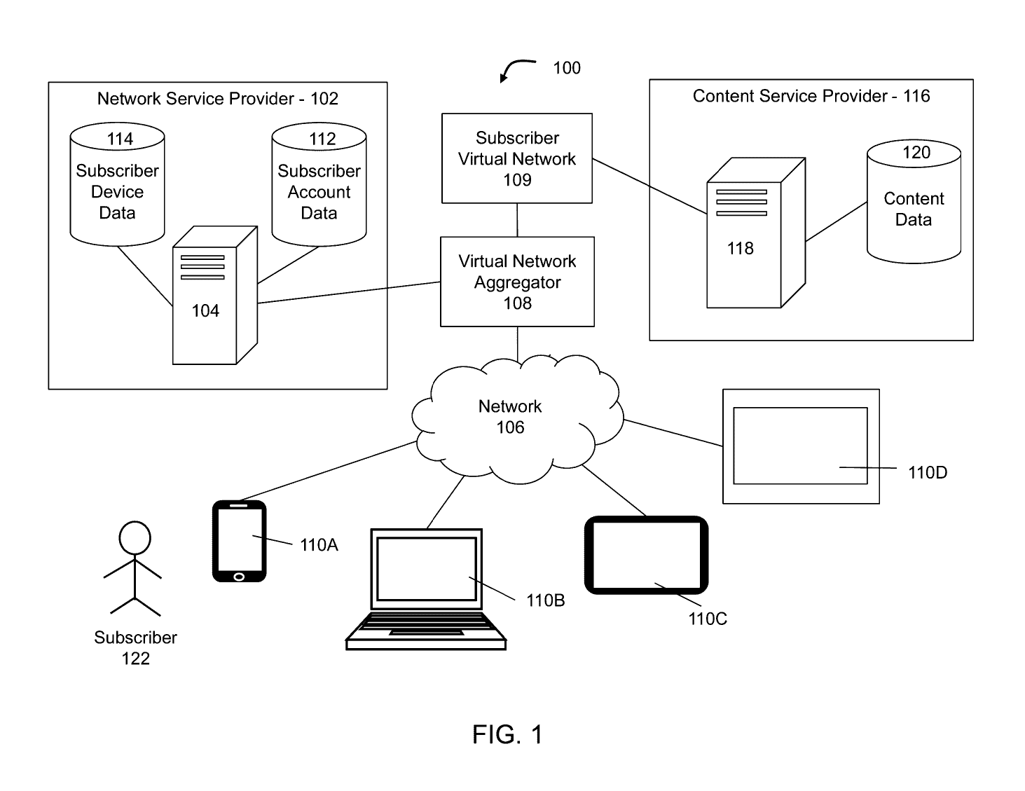

Referring now to the drawings in which like numerals represent like elements or steps throughout the several views, FIG. 1 is block diagram of example environment 100 for providing external entity network service authentication in accordance with the present disclosure. Example environment 100 may comprise network service provider 102, such as an Internet Service Provider, or Cable Television Provider, that includes network service provider server 104 attached to multiple data repositories including subscriber account data 112 and subscriber device data 114.

Data from network service provider 102 may be transmitted for distribution over network 106 to one or more networked devices 110A-D for use by subscriber of user 122. Content may either be sent directly to networked devices 110A-D or sent via subscriber virtual network 109 via virtual network aggregator 108 (also a networked device) for use on networked devices 110A-D. Examples of data include audio, video, system clock times, and/or other data and/or signals, instructions, directions, and messages. It will be appreciated that networked devices 110A-D are also referred to herein as subscriber devices.

Content from content service provider 116 may be transmitted for distribution over network components 106, 108, and 109 to one or more networked devices 110A-D. Content may either be sent directly to networked devices 110A-D or to networked devices 110A-D over a tunneled network connection via subscriber virtual network 109 and virtual network aggregator 108. According to further embodiments of the present disclosure, content service provider 116 may be an external third party network and distinct from network service provider 102. By way of example and not limitation, content service providers may include Google, Google Play, Hulu, CBS Network Website, Netflix, Redbox, Amazon Prime Video, iTunes, XBOX, YouTube, Vimeo, Pandora, Apple Music, and Spotify. It will be appreciated that other third party sources may be configured according to user preferences as well, such as accessing a public or university library media service. Additionally, content service providers may include portals and/or websites such as LinkedIn, Facebook, Reddit, and MySpace.

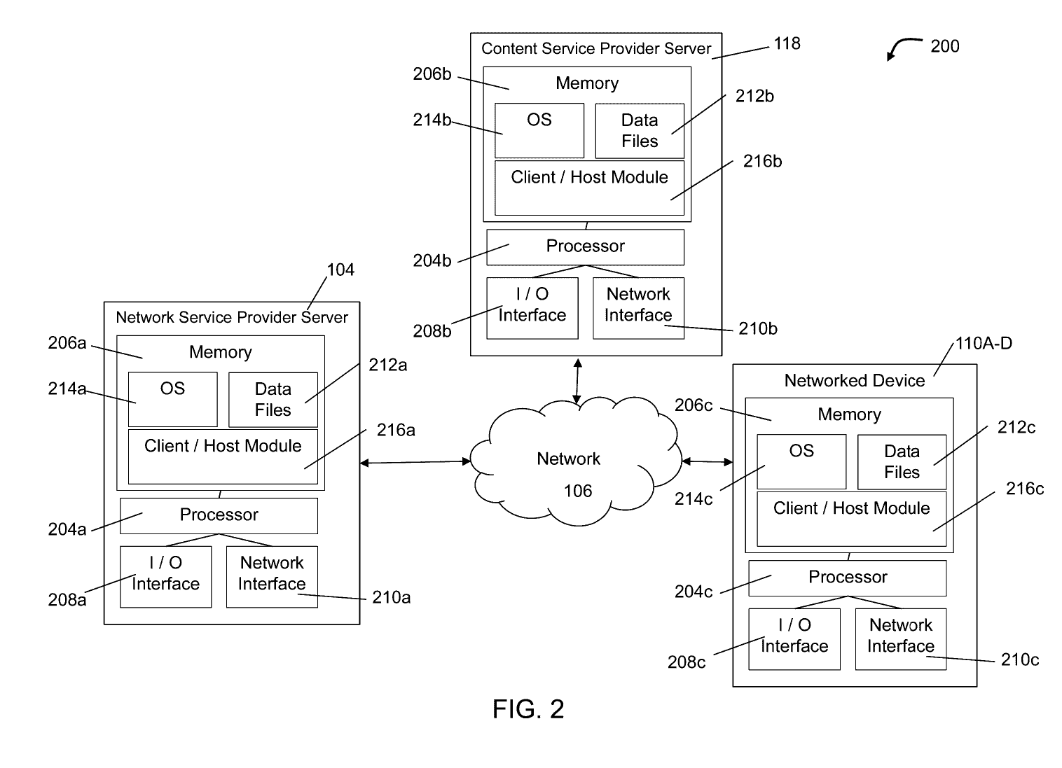

Service provider server 104 may comprise a computing device as described below with respect to FIG. 2. Consistent with embodiments of the disclosure, service provider server 104 may comprise one or more software applications (i.e., a series of instructions configured for execution by a processing unit) associated with another component, such as one or more servers or dedicated content devices. Additionally, service provider server 104 may include remotely accessible features and functions that are the same as those of content service provider server 118 to serve as cloud or network based DVR.

Network 106 (also referred herein as distribution network or communication network) is, generally, used and implemented by a cable service provider (such as, but not limited to, a wired and/or wireless communication service provider) to enable the service provider to provide, and the service provider's subscribers to receive content and communication services. Network 106 additionally refers to infrastructure, including apparatuses and methods, operative and utilized to communicate data and/or signals between networked devices such as service provider server 104, content service provider server 118, and networked devices 110A-D. Similarly, for example and not limitation, network 106 may include current and future wired and/or wireless communication infrastructure for communicating video, audio, or other data and/or signals such as the public switched telephone communication network, cable and/or satellite telecommunications service provider communication networks, other service provider communication networks, and the Internet.

Additionally, network 106 may include any telecommunication and/or data network, whether public, private, virtual, or a combination thereof, including a local area network, a wide area network, an intranet, an internet, the Internet, home gateways, roaming Wi-Fi, visiting gateways, intermediate hand-held data transfer devices, and/or any combination thereof and may be wired and/or wireless. Network 106 may also allow for real-time, off-line, and/or batch transactions to be transmitted between or among service provider server 104, content service provider server 118, and networked devices 110A-D. Due to network connectivity, various methodologies as described herein may be practiced in the context of distributed computing environments.

Although content service provider server 118 is shown for simplicity in FIG. 2 in an example embodiment as being in communication with service provider server 104 via one intervening network 106, it is to be understood that other network configurations may be used. For example, intervening network 106 may include a plurality of networks, such as virtual network aggregator 108, and subscriber virtual network 109, each with devices such as gateways and routers for providing connectivity between or among networks. Instead of, or in addition to network 106, dedicated communication links may be used to connect the various devices in accordance with example embodiments of the disclosure. For example, content provider server 118 may form the basis of network 106 that interconnects one or more networked devices 110A-D.

As shown in FIG. 1, components of example environment 100, including service provider 102, service provider server 104, content provider server 118, and networked devices 110A-D may be in communication with each other via a network such as network 106 and virtual network aggregator 108, which as described herein can include one or more separate or shared private and public networks, including the Internet or a publicly switched telephone network.

Consistent with embodiments of the disclosure, content provider server 118 may comprise one or more software applications (i.e., a series of instructions configured for execution by a processing unit) associated with another component, such as one or more servers or dedicated content devices. Additionally, content provider server 118 may include a stand alone device (or integrated devices) such as a pc, media server, television tuner, satellite or cable receiver, digital video recorder, video game console, Blu-ray player, tablet, smart device, embedded devices, and the like. Networked devices 110A-D may include one or more of video playback screen, tablet device, smart phone, PDA, or other devices with one or more connectivity options. Networked devices 110A-D may further include an LCD display device such as a monitor featuring an operating system, media browser, and the ability to run one or more software applications.

Service provider server 104 is shown in communication with multiple data repositories including subscriber account data 112 and subscriber device data 114. It will be appreciated that the terms subscriber and user are used interchangeably herein. It will further be appreciated that the terms networked and connected are used interchangeably herein. While illustrated as separate data repositories, it is to be understood that information included in repositories 112 and 114 may be stored in a single repository, or multiple repositories across different locations. Content provider server 118 is shown in communication with content data repository 120.

In an example embodiment, subscriber account data 112 and subscriber device data 114 may include remote or cloud based storage of device preferences. Such information may be useful for backup and restoration purposes should a subscriber need to replace or upgrade one or more devices such as one or more networked devices 110A-D.

Through mechanisms available to network service provider 102, subscriber network information stored in one or more of subscriber account data repository 112 and subscriber device data repository 114 is made available to content service provider 116 via peering agreement. Subscriber network information including subscriber device data 114, enables content service provider 116 with the ability to automatically and securely authenticate/authorize subsequent requests for access to a service on the subscriber device. Furthermore, network service provider 102 may use subscriber network information, as well as subscriber-managed data, including entitlement setting information, to distinguish between various users on an account, such as parents vs. children.

FIG. 2 illustrates example system 200 for supporting provision of external entity network service authentication according to an example embodiment of the disclosure. Service provider server 104, content provider server 118, and networked devices 110A-D may be any processor-driven device, such as, but not limited to, a personal computer, laptop computer, handheld computer, dedicated processing device, and/or an array of computing devices. In addition to having processor 204a-c, server 104, content provider server 118, and networked devices 110A-D may further include memory 206a-c, input/output (“I/O”) interface(s) 208a-c, and network interface 210a-c. Memory 206a-c may be any tangible computer-readable medium, coupled to the processor, such as RAM, ROM, and/or a removable storage device for storing data files 212a-c and a database management system (“DBMS”) to facilitate management of data files 212a-c and other data stored in memory 206a-c and/or stored in separate databases. Memory 206a-c may store data files 212a-c and various program modules, such as operating system (“OS”) 214a-c and client module 216a-c. OS 214a-c may include examples such as, but not limited to, Microsoft Windows®, Apple OSX™, Unix, Linux, Android, or a mainframe operating system. Client module 216a-c may include an Internet browser or other software, including a dedicated program, for interacting with server 104, network 106, content provider server 118, and/or networked devices 110A-D.

Suitable processors, such as processors 204a-c of service provider server 104, content provider server 118, and networked devices 110A-D, respectively, may comprise a microprocessor, an ASIC, and/or a state machine. Example processors may include those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein.

Generally, each of the memories and data storage devices, such as memories 206a-c and databases 112, 114, and 120 (as shown in FIG. 1), and/or any other memory and data storage device, may store data and information for subsequent retrieval. In this manner, systems may store various received or collected information in memory or a database associated with network service provider server 104, content service provider server 118, and/or networked devices 110A-D. The memories and databases may be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown may be integrated or distributed into any number of databases or other data storage devices.

As used herein, the term “computer-readable medium” may describe any form of memory or a propagated signal transmission medium. Propagated signals representing data and computer program instructions may be transferred between network devices and systems. Embodiments of computer-readable media include, but are not limited to, electronic, flash, optical, magnetic, or other storage or transmission devices capable of providing a processor with computer-readable instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Generally, network service provider server 104, content service provider server 118, and networked devices 110A-D comprise hardware and/or software for transmitting and receiving data and/or computer-executable instructions over a communications link and a memory for storing data and/or computer-executable instructions. These devices and systems may also include a processor for processing data and executing computer-executable instructions locally and over network 106, as well as other internal and peripheral components that are well known in the art.

Still referring to network service provider server 104, content service provider server 118, and networked devices 110A-D, I/O interface(s) 208a-c may facilitate communication between processor 204a-c and various I/O devices, such as a keyboard, mouse, printer, microphone, speaker, monitor, bar code readers/scanners, RFID readers, and the like. Network interface 210a-c may take any of a number of forms, such as a network interface card, a modem, a wireless network card, and the like. It will be appreciated that while service provider server 104, content provider server 118, and networked devices 110A-D have been illustrated as a single computer or processor, network service provider server 104, content service provider server 118, and networked devices 110A-D may be comprised of a group of computers or processors, according to an example embodiment of the disclosure.

As previously mentioned, network 106 may take many forms, including a public and/or a private network, such as a cable television distribution network (e.g., a hybrid fiber-coax network), a cellular data network, a metropolitan network, and/or the Internet.

Example environment 100 shown in and described with respect to FIGS. 1 and 2 is provided by way of example only. Numerous other operating environments, system architectures, and device configurations are possible. Other system embodiments may include fewer or greater numbers of components and may incorporate some or all of the functionality described with respect to the system components shown in FIGS. 1 and 2.

For example, in one embodiment, network service provider server 104 (or content provider server 118/networked devices 110A-D) may be implemented as a specialized processing machine that includes hardware and/or software for performing the methods described herein. In addition, the processor and/or processing capabilities of content service provider server 104, may be implemented as part of content service provider server 118, networked devices 110A-D, or any portion or combination thereof. Accordingly, embodiments of the disclosure should not be construed as being limited to any particular operating environment, system architecture, or device configuration.

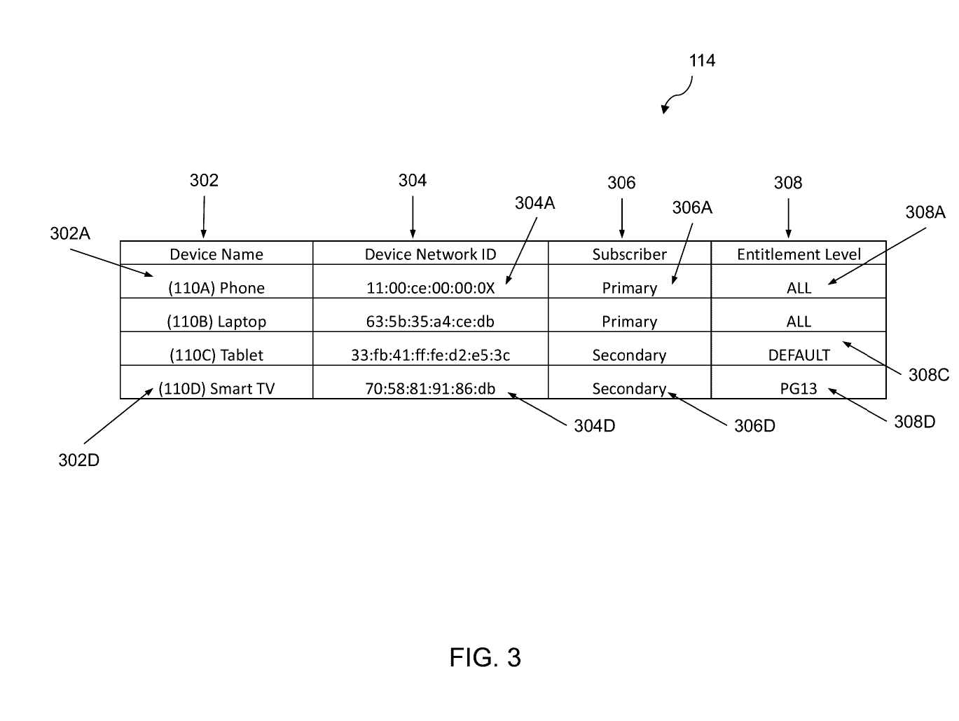

FIG. 3 schematically illustrates information from subscriber device data repository 114 in accordance with an example embodiment of the disclosure. Subscriber device data 114 includes device name 302, device network id 304, subscriber ID 306, and entitlement level 308 columns. Field 302A shows that the device name is Phone 110A, from FIG. 1. It will be appreciated that device name 302 may include one or more descriptors including user assigned device names, such as iPad 2, Harley's Phone, or the like.

Field 304A indicates that the device network id that corresponds to phone 110A is “11:00:ce:00:00:0X”. Device Network ID 304 may include any number of device identifiers including MAC addresses, serial numbers, hardware designator, or other unique identifier.

As shown, field 306A indicates that the subscriber associated with phone 110A is the “Primary” subscriber. It should be noted that subscriber ID 306 may be identified in a variety of ways including names, usernames, email addresses, and the like.

Field 308A indicates that the entitlement level associated with phone 110A is “ALL”. Entitlement level 308 may be designated in any number of ways ranging from broad (308A “ALL”) to a more granular manner (308D “PG13”). Field 302D shows that the device name is Smart TV 110D, from FIG. 1. Field 304D indicates that device network id is “70:58:81:91:86:db”. Field 306D indicates that the subscriber associated with Smart TV 110D is “Secondary” subscriber. Field 308D indicates that entitlement level associated with Smart TV 110D is “PG13”. Field 308C indicates that the entitlement level associated with Tablet 110C is “DEFAULT”.

It will be appreciated, by agreement between network service provider 102 and content service provider 116, information included in subscriber device data repository 114 may be shared with content service provider 116. Additionally, content service provider 116 may store or copy the same information in content data repository 120 depicted in FIG. 1.

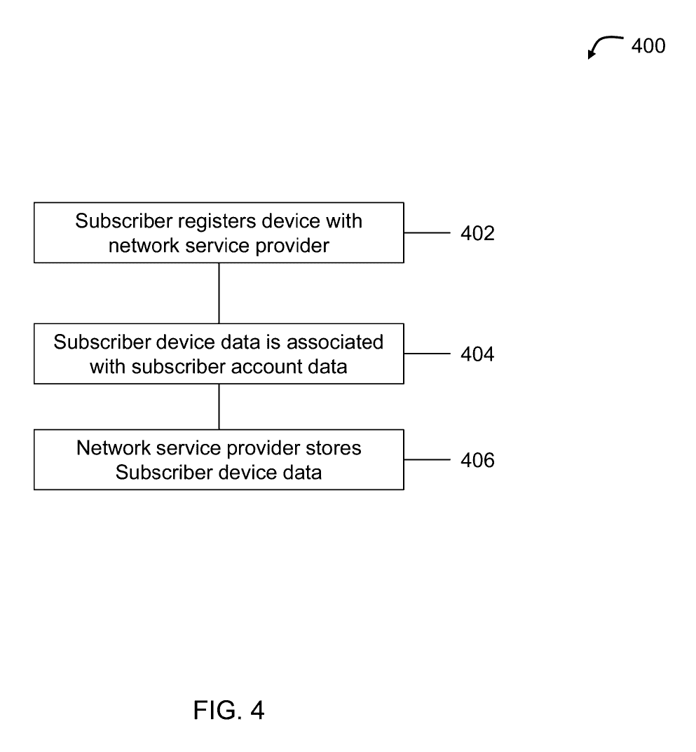

FIG. 4 is an example flow diagram illustration of instructions 400 for providing external entity network service authentication in accordance with an example alternate embodiment of the disclosure. In block 402, subscriber registers device with network service provider as may be the case when a subscriber obtains a new device or a device that has not been previously used or registered with network provider. In block 404, subscriber device data is associated with subscriber account data. As previously described with respect to FIG. 3, examples of subscriber device data may include device name 302, device network id 304, subscriber 306, and entitlement level 308. In block 406, network service provider stores subscriber device data.

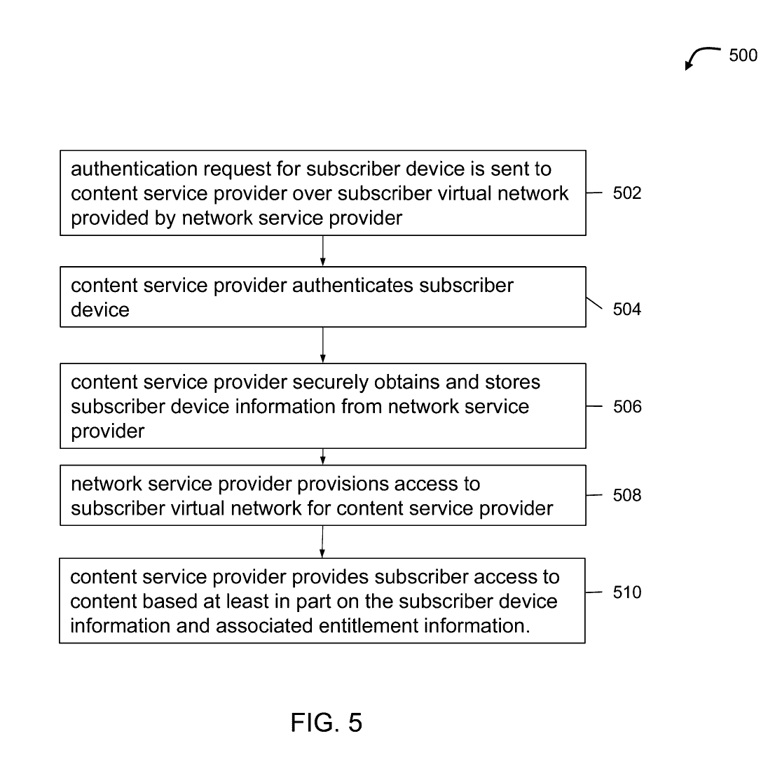

FIG. 5 is an example flow diagram illustration of instructions 500 for providing external entity network service authentication in accordance with an example embodiment of the disclosure. In block 502, an authentication request for a subscriber device is sent to content service provider over subscriber virtual network provided by network service provider. In block 504, content service provider authenticates the subscriber device. In block 506, content service provider securely obtains and stores subscriber device information from network service provider. In block 508, network service provider provisions access to subscriber virtual network for content service provider. In block 510, content service provider provides subscriber access to content based at least in part on the subscriber device information and associated entitlement information.

It will be appreciated by one of ordinary skill in the art that the steps/instructions set forth in FIGS. 4 and 5 may be performed on service provider server 104, content provider server 118, or networked devices 110A-D.

The flow diagrams of FIGS. 4 and 5 show the architecture, functionality, and operation of a possible implementation of providing an external entity network authentication. In this regard, each block represents a module, segment, or portion of code, which comprises one or more executable instructions for implementing the specified logical function(s). It should also be noted that in some alternative implementations, the functions noted in the blocks may occur out of the order noted in FIGS. 4 and 5. For example, two blocks shown in succession in FIGS. 4 and 5 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

Any process descriptions or blocks in flow charts should be understood as representing modules, segments, or excerpts of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A system for performing external entity network authentication, comprising:
a processor comprising a computer-readable medium with a set of instructions operable to:
receive an authentication request for a subscriber device at a content service provider, the subscriber device request sent over a subscriber virtual network;
authenticate the subscriber device at the content service provider;
request subscriber device information from the network service provider at the content service provider;
at the network service provider, provision access to the subscriber virtual network to the content service provider; and
provide access to content on the subscriber device based at least in part on the subscriber device information.

2. The system of claim 1 wherein the subscriber device information includes a subscriber device MAC address.

3. The system of claim 1, wherein the subscriber device information includes an entitlement level.

4. The system of claim 1, further including the instruction to securely obtain the subscriber device information from the network service provider.

5. The system of claim 1, wherein the subscriber device information includes a subscriber profile.

6. The system of claim 5, wherein the subscriber device information further includes an entitlement level associated with the subscriber profile.

7. A system for performing external entity network authentication, comprising:
a processor comprising a computer-readable medium with a set of instructions operable to:
receive an authentication request at a content service provider, the authentication request sent for a subscriber device over a subscriber virtual network provided by a network service provider;
securely obtain subscriber device information from the network service provider;
at the network service provider, provision access to the subscriber virtual network to the content service provider; and
provide access to content on the subscriber device based at least in part on the subscriber device information.

8. The system of claim 7 wherein the subscriber device information includes a subscriber device MAC address.

9. The system of claim 7, wherein the subscriber device information includes an entitlement level.

10. The system of claim 7, wherein the subscriber device is connected to the network service provider via virtual network aggregator

11. The system of claim 7, wherein the subscriber device information includes a subscriber profile.

12. The system of claim 11, wherein the subscriber device information further includes an entitlement level associated with the subscriber profile.

13. A system for performing external entity network authentication, comprising:
a processor comprising a computer-readable medium with a set of instructions operable to:
receive an authentication request for a subscriber device at a content service provider, the subscriber device request sent over a network service provider network;
authenticate the subscriber device at the content service provider;
securely obtain subscriber device information from the network service provider at the content service provider; and
provide access to content on the subscriber device based at least in part on the subscriber device information.

14. The system of claim 13 wherein the instruction to provide access to content on the subscriber device based at least in part on subscriber device information further includes the instruction to determine an entitlement level associated with the subscriber device.

15. The system of claim 13 wherein the subscriber device information includes a device MAC address.

16. The system of claim 13, wherein the subscriber device is connected to the network service provider via a virtual network aggregator.

17. The system of claim 13, wherein the instruction to securely obtain subscriber device information from the network service provider at the content service provider is performed using a secure authorization method.

18. The system of claim 13, wherein the subscriber device information includes a subscriber profile.

19. The system of claim 18, wherein the subscriber device information further includes an entitlement level associated with the subscriber profile.
